(19) United States
(12) Patent Application Publication
(10) Pub. No.: US 2022/0022102 A1
(43) Pub. Date: Jan. 20, 2022

(54) METHOD FOR SUPPORTING VOICE SERVICE CONTINUITY AND EDGE APPLICATION SERVER USING THE SAME

(71) Applicant: Industrial Technology Research Institute, Hsinchu (TW)

(72) Inventor: Samer T. Talat, Hsinchu County (TW)

(73) Assignee: Industrial Technology Research Institute, Hsinchu (TW)

(21) Appl. No.: 17/117,119

(22) Filed: Dec. 10, 2020

Related U.S. Application Data
(60) Provisional application No. 63/052,448, filed on Jul. 15, 2020.

(51) Int. Cl. H04W 36/00; H04W 36/14; H04L 29/06; H04W 80/10

(52) U.S. Cl. CPC H04W 36/0022; H04W 36/14; H04W 80/10; H04L 65/1083; H04L 65/1016

(57) ABSTRACT

An aspect of the disclosure includes a method for supporting voice service continuity, including: establishing a connection between an edge application server and a core network; and providing an IMS function to transmit an IMS information element to the core network by the edge application server during a handover procedure related to an IMS voice service.

### CROSS-REFERENCE TO RELATED APPLICATION

This application claims the priority benefit of U.S. provisional application Ser. No. 63/052,448, filed on Jul. 15, 2020. The entirety of the above-mentioned patent application is hereby incorporated by reference herein and made a part of this specification.

### TECHNICAL FIELD

This disclosure is directed to a method for supporting voice service continuity and an edge application server using the same.

### BACKGROUND

The throughput of wireless communication systems has increased significantly by new technologies introduced in LTE. These technologies, however, are not sufficient to meet the demands of future applications which will require 10 G bits/sec of throughput and latencies of 1 ms. Therefore, research on a next-generation communication system, known as the 5G, has already started. As the applications and ubiquity of cellular communication systems grow, they are expected to support new features and meet a more stringent set of performance requirements. It is therefore desirable that the next generation communication system be flexible and capable of providing high-speed communications services for a wide ambit of devices under a multiplicity of circumstances.

Edge computing is acknowledged as one of the key points for meeting the above demanding of the next generation communication system, especially low latency and bandwidth efficiency are concerned. Edge computing as an evolution of cloud computing brings application hosting from centralized data centers down to the network edge, closer to consumers and the data generated by applications. With edge computing deployment, it is expected that a set of edge computing functions or edge application servers running on an edge hosting environment will need to interact with the 5G system to access to 5G system functionality and information, and/or to provide information to 5G system for the provisioning of connectivity services supporting edge computing. That is, in 5G system, which information needs to be exposed with low latency to the edge computing functions and how to expose the network information to the application functions deployed in the edge with low latency are important topics to be addressed by persons skilled in the art.

### SUMMARY

Accordingly, the disclosure is directed to a method for supporting voice service continuity and an edge application server using the same.

In one of the exemplary embodiments, the disclosure is directed to a method for supporting voice service continuity, and the method would include but not limited to establishing a connection between an edge application server and a core network; and providing an IMS function to transmit an IMS information element to the core network by the edge application server during a handover procedure related to an IMS voice service.

In one of the exemplary embodiments, the disclosure is directed to an edge application server which would include not limited to: a transceiver, and a processor coupled to the transceiver, and configured to establishing a connection between an edge application server and a core network; and providing an IMS function to transmit an IMS information element to the core network by the edge application server during a handover procedure related to an IMS voice service.

It should be understood, however, that this summary may not contain all of the aspects and embodiments of the disclosure and is therefore not meant to be limiting or restrictive in any manner. Also, the disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a service-based architecture of 5G system according to an embodiment of the disclosure.

FIG. 2 is a schematic diagram of modified network architecture with an edge application server according to an embodiment of the disclosure.

FIG. 3 is a schematic diagram of 5G-SRVCC architecture for NG-RAN to 3GPP UTRAN according to an embodiment of the disclosure.

FIG. 4 is a flowchart of a method for supporting voice service continuity according to an embodiment of the disclosure.

FIG. 5 is a flowchart of a method for supporting voice service continuity according to an embodiment of the disclosure.

FIG. 6 is a flowchart of a method for supporting voice service continuity according to an embodiment of the disclosure.

FIG. 7 is a flowchart illustrating a method for supporting voice service continuity according to an embodiment of the disclosure.

FIG. 8 is a block diagram illustrating an edge application server according to an embodiment of the disclosure.

### DESCRIPTION OF THE EMBODIMENTS

In order to make the aforementioned features and advantages of the disclosure comprehensible, exemplary embodiments accompanied with figures are described in detail below. It is to be understood that both the foregoing general description and the following detailed description are exemplary, and are intended to provide further explanation of the disclosure as claimed.

Reference will now be made in detail to the embodiments of the disclosure, examples of which are illustrated in the accompanying drawings. Wherever possible, the same reference numbers are used in the drawings and the description to refer to the same or like parts.

For the definition of the term “network function” in the embodiments of the disclosure, for example, reference may be made to the “3GPP TS 23.501” specification. For example, the network function may include (but not limited to) a network element on dedicated hardware, a software instance running on dedicated hardware, or a virtualized function instantiated on an appropriate platform (e.g., a cloud infrastructure).

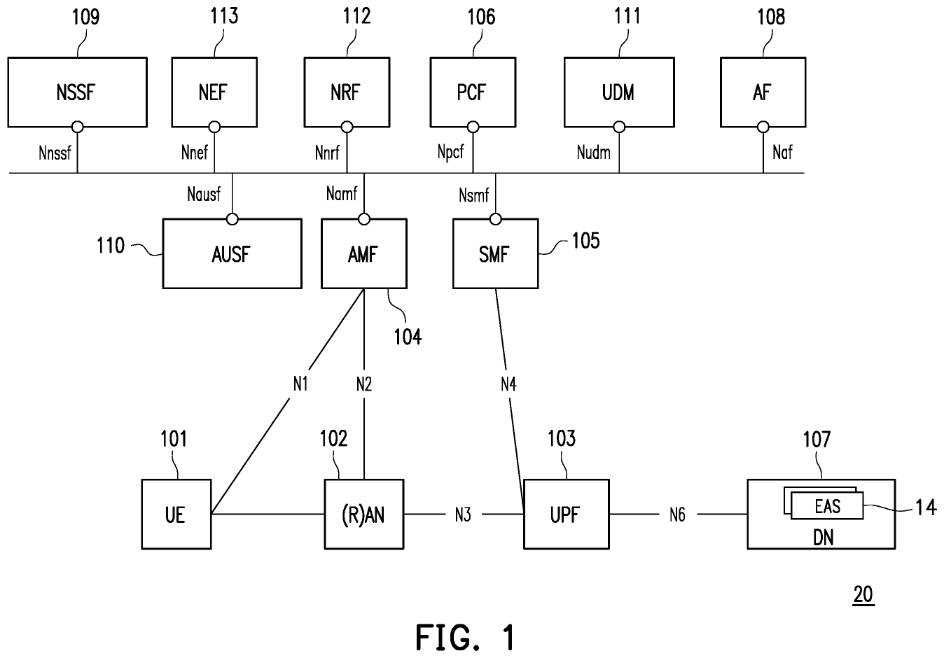

FIG. 1 is a service-based architecture of 5G system according to an embodiment of the disclosure. With reference to FIG. 1, network entities and network functions in a service-based architecture 10 may include: A user equipment (UE) 101, a (radio)access network ((R)AN) 102, a user plane function (UPF) 103, an access and mobility management function (AMF) 104, a session management function (SMF) 105, a policy control function (PCF) 106, a data network (DN) 107, an application function (AF) 108, a network slice selection function (NSSF) 109, an authentication server function (AUSF) 110, a unified data management (UDM) 111, a network function (NF) repository function (NRF) 112 and a network exposure function (NEF) 113. The UE 101 may be connected to the (R)AN 102 and served by the network functions responsible for different professional services in 5G system in order to communicate with other devices in the DN 107. Basic specification and definition of 5G system may refer to “3GPP TS 23.501”.

With reference to FIG. 1, the network functions on a control plane in the service-based architecture 10 can access services of other network functions on the control plane through service-based interfaces. For example, the AMF 104 can enable other authorized network functions for accessing the service provided by the AMF 104 through a service interface Namf. When various system procedures are being performed, interactions and message passing between the network functions may refer to the “3GPP TS 23.501” and “3GPP TS 23.502” specification.

In an embodiment of the disclosure, the term “user equipment (UE)” may represent various embodiments, which may include (but not limited to), for example, a mobile station, an advanced mobile station (AMS), a server, a user terminal, a desktop computer, a laptop computer, a network computer, a workstation, a personal digital assistant (PDA), a personal computer (PC), a scanner, a phone device, a pager, a camera, a television, a handheld video game console, a music device, a wireless sensor and the like. In certain applications, the UE may be a fixed computer device operated in a mobile environment including bus, train, airplane, boat, car, etc.

In an embodiment of the disclosure, a (radio) access network ((R)AN) (e.g., the (R)AN 102 in FIG. 1) between a core network (CN) and the UE in 5G system includes at least one access node, and the UE may be connected to the access node in the (R)AN in wired or wireless manners to obtain the 5G system service. For instance, the (R)AN of 5G system may include a next-generation radio access node (NG-RAN node) such as a next-generation access node B (gNodeB or gNB). Alternatively, the (R)AN of 5G system, also referred as a base station in the embodiment of the disclosure, may also include a home evolved node B (HeNB), an evolved node B (eNB) or a non-3GPP access point, etc.

To describe the embodiment of the disclosure more clearly, the 5G system architecture 10 of FIG. 1 is taken as an example for introducing various network functions. In an embodiment of the disclosure, the AMF 104 may be a termination of a RAN control plane (CP) interface and a non-access stratum message (NAS message), and the AMF 104 may be responsible for registration management, connection management and mobility management related to the UE. In addition, the AMF 104 is also responsible for access authentication and access authorization related to the UE.

In an embodiment of the disclosure, the NRF 112 can support a service discovery function, and provide information regarding a discovered network function (be discovered) to other network functions in response to the NF discovery requests received from the other network functions. In addition, the NRF 112 may maintain a network function profile (NF profile) of a network function instance and the service supported by the network function instance.

In an embodiment of the disclosure, the SMF 105 may be responsible for certain settings of a user plane, as well as establishment, modification and release of a packet data unit (PDU) session between the UPF 103 and RAN node (e.g., determining a routing path for packets). The UPF 103 may be responsible for routing and forwarding of packets and is a positioning anchor point for processing Intra-/Inter-RAT mobility in a wireless access technology as well as a PDU session point for interconnecting to the DN 107.

In an embodiment of the disclosure, the PCF 106 can support a unified policy framework to govern network behavior and provides policy rules to be followed by the network functions on the control plane. The AUSF 110 may be used to verify whether the UE is a legal service requester, and supports an authentication server function established by SA WG3 workgroup. The UDM 111 can support an authentication credential repository and processing function. That is to say, the UDM 111 may be used to store authentication data related to the UE.

In an embodiment of the disclosure, the NEF 113 can securely expose the services and capabilities provided by 5G system functions, for example, for a 3rd party, internal exposure/re-exposure, an application function, and edge computing entities. The NEF can receive information from other network functions based on the exposed capabilities of other network functions. The NEF 113 may store information received as structured data using a standardized interface as a data storage network function. The stored information may be exposed by the NEF 113 and may be used for other purposes. For example, the NEF 113 may provide Nnef_AFsessionWithQoS service that uses the IP address and flow descriptor to support Quality of Service (QoS) monitoring for Ultra-Reliable and Low Latency Communications (URLLC). In an embodiment of the disclosure, a consumer may request the 5G system to provide specific QoS information for an application-level session (AF session). The NEF 113 may include a common application programming interface (API) framework (CAPIF) core function. The CAPIF core function provides a common API for other devices to access network functions.

It should be noted that, in an embodiment of the disclosure, an edge application server (EAS) 114 is disposed in the DN 107. The definition of edge computing may refer to “chapter 5.13 of 3GPP TS 23.501” specification. Edge computing enables operator and 3rd party services to be hosted close to the UE's access point of attachment, so as to achieve an efficient service delivery through the reduced end-to-end latency and load on the transport network. The 5G system may expose network information and capabilities to the edge application server 114 through services provided by the NEF 113 or a Network Data Analytics Function (NWADF) (not illustrated in FIG. 1). In an embodiment of the disclosure, the edge application server 114 is deployed close to the UE 101 to reduce interaction latency between the edge application server 114 and the UE 101. The definition of the term “edge application server” may refer to the “3GPP TR 23.748” specification, wherein the edge application server is an application server resident in the edge hosting environment.

In an embodiment of the disclosure, a handover procedure related to an IP multimedia subsystem (IMS) voice service may be performed due to UE's mobility, UE's capability, radio channel condition, network configuration, or network capability, etc. Specifically to say, in some cases, if voice over new radio (VoNR) is not supported, many operators may rely on LTE systems to provide voice service in 5G systems. That is, the 5G system may initiate a handover procedure for the UE 101 to fallback to an LTE system for IMS voice service. In some cases, if the UE 101 moves out of the coverage of the 5G system, then the operators may rely on an LTE system for IMS voice calls. However, if voice over LTE (VoLTE) is not supported by the LTE system, then the UE 101 may further fallback to second-generation/third generation (2G or 3G) system for voice service. The handover procedure may include a single radio voice call continuity (SRVCC) procedure from new-generation radio access network (NG-RAN) to UMTS terrestrial radio access network (UTRAN) circuit-switched (CS) domain, a radio access technology (RAT) fallback procedure for IMS voice, etc.

During the handover procedure, some IMS functions should be implemented for supporting voice service continuity. In an embodiment of the disclosure, the edge application server 114 may provide some IMS functions to transmit an IMS information element to a core network. For example, the IMS information element may include a priority level of the QoS flow, etc, and the IMS functions included in the edge application server 114 may include a call session control function (CSCF), a service centralization and continuity application server (SCC AS), etc. By using the edge application server 114 providing the IMS functions, handover latency can be reduced since the edge application server 114 is deployed close to the UE 101.

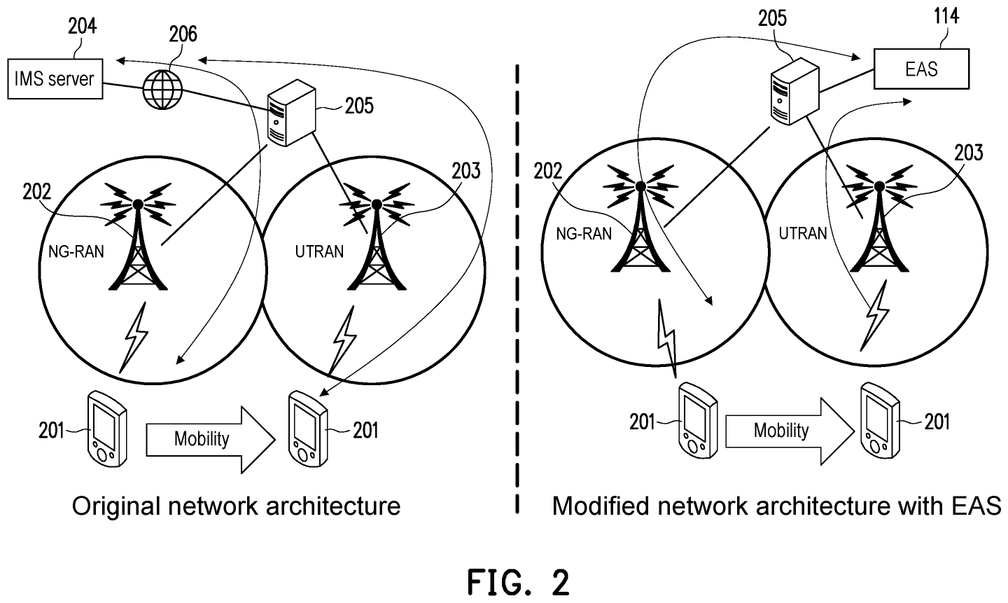

FIG. 2 is a schematic diagram of modified network architecture with an edge application server according to an embodiment of the disclosure. Referring to FIG. 2, in the original network architecture without any edge application server, when the UE 201 is handover from NG-RAN 202 to UTRAN 203 due to UE's mobility, a session-related procedure for initializing or re-initializing a PDU session may be performed with an IMS server 204 which is connected to the core network 205 via internet 206. That is, the UE 210 should connect to the IMS server 204 through TCP/IP protocol, and the site of the IMS server 204 may be far from the UE 201. Therefore, the latency of the handover procedure related to the IMS voice procedure may bring adverse effects to the voice service that need to be real-time. By contrast, in the modified network architecture with the edge application server 114, when the US 201 is handover from NG-RAN 202 to UTRAN 203 due to UE's mobility, a session-related procedure for initializing or re-initializing a PDU session may be performed with the edge application server 114 which provides IMS functions and is deployed close to the UE 201. The core network 205 may include the network functions as described in FIG. 1, and the edge application server 114 may connect to a UPF in the core network 205. Therefore, the IMS voice service can be continued and the latency caused by the handover procedure can be reduced.

In an embodiment of the disclosure, the discovery of the edge application server 114 can be triggered by events in the 5G system. In detail, the discovery of the edge application server 114 can be triggered by a user plane change initiated by the network such as a mobility event (e.g. handover). In an embodiment of the disclosure, the discovery of the edge application server 114 can be utilized in response to the handover procedure or an IMS voice establishment procedure. Besides, the discovery of the edge application server 114 can be performed by using domain name system (DNS) query. For example, the other edge application server may use a DNS query to identify the edge application server 114 having IMS functions.

In an embodiment of the disclosure, the IMS voice service is associated with a mission-critical (MC) service. The mission-critical service, for example, maybe V2X service, media and entertainment service, eHealth service, MC push-to-talk service, etc. Mission-critical services are services that are provided to users of MC organizations. In an embodiment of the disclosure, based on the IMS functions provided by the edge application server 114, the edge application server 114 can perform an SRVCC procedure from NG-RAN to UTRAN for a mission-critical service. That is, the IMS voice service is established based on a mission-critical service.

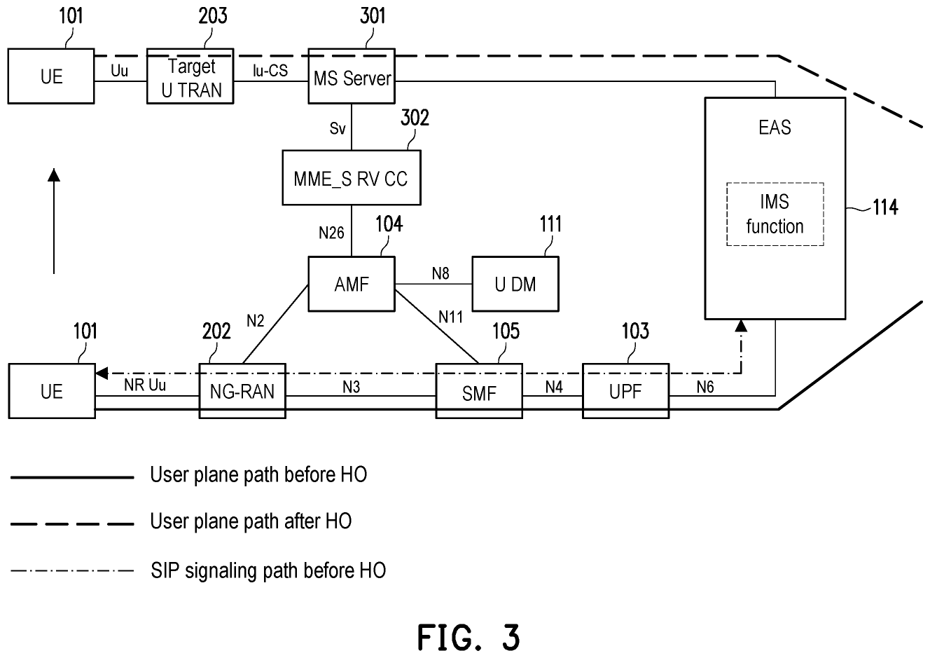

FIG. 3 is a schematic diagram of 5G-SRVCC architecture for NG-RAN to 3GPP UTRAN according to an embodiment of the disclosure. Referring to FIG. 3, edge application server 114 connects to the UPF 103, and the edge application server 114 in the data network 107 is connected to the UE 101 via the UPF 103. Further, the edge application server 114 in the data network 107 is connected to the Mobile Switching Center (MSC) server 301. The edge application server 114 providing the IMS functions may be a destination of the Session Initiation Protocol (SIP) signaling path. In an embodiment of the disclosure, the edge application server 114 is able to perform the SIP procedure to provide IMS voice service to the UE 101. The UE 101 may access the IMS functions provided by the edge application server 114 by using an established PDU session, and the PDU session information related to the IMS voice service may be obtained by the edge application server 114. In an embodiment of the disclosure, after the NG-RAN 202 triggers the 5G-SRVCC procedure, the session-related procedure may be performed by the edge application server 114 according to the PDU session information related to the IMS voice service, such as QoS information of the IMS voice service, during the 5G-SRVCC procedure. After the 5G-SRVCC procedure is completed, the user plane path may be switched to CS domain, and the UE 101 may transmit the user plane data through the target UTRAN 203 and the MSC server 301.

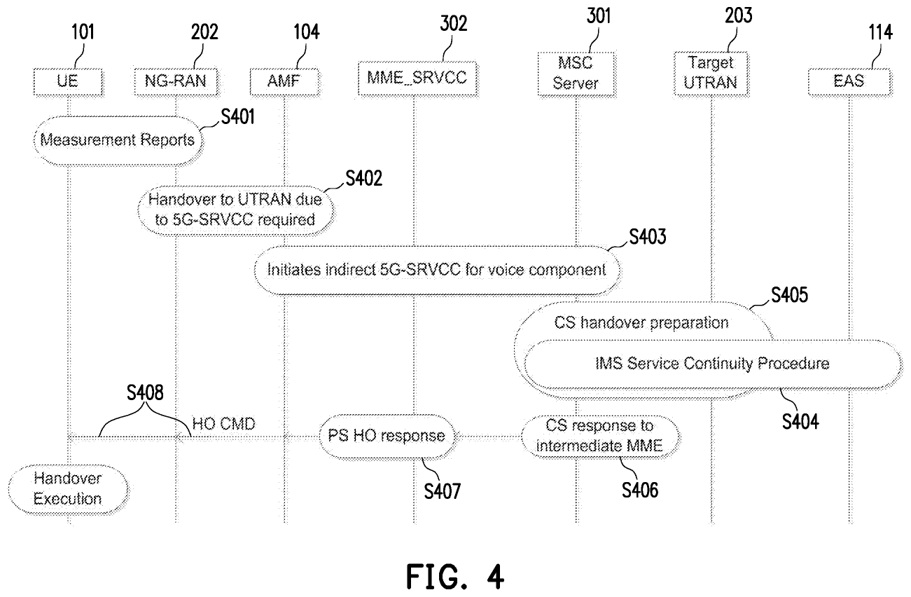

FIG. 4 is a flowchart of a method for supporting voice service continuity according to an embodiment of the disclosure. Referring to FIG. 4, in the step S401, the NG-RAN 202 receives the measurement reports from the UE 101. The NG-RAN 202 may be an example of aspects of RAN 102 as described with reference to FIG. 1. In an embodiment of the disclosure, if the channel conditions and capability of NG-RAN 202 are insufficient to support the performance requirement of IMS voice service, the NG-RAN 202 may trigger a voice handover procedure to 2G or 3G systems (e.g., systems employing GERAN or UTRAN). In one example, the NG-RAN 202 may configure the UE 101 to measure the 2G or 3G neighboring base stations for handover. Upon receiving the measurement reports associated with the target base station in 2G/3G system, in the step S402, the NG-RAN 202 may send a handover request to the AMF 104 associated with the 5G system. In the step S402, AMF 104 may first receive the handover request from NG-RAN 202 with the indication that is for 5G-SRVCC handling, and then the AMF 104 may select an MME_SRVCC 302 to relay the handover request.

In the step S403, AMF 104 sends the forward relocation request with 5G-SRVCC HO Indication to MME_SRVCC 302 together with Session Transfer Number for SRVCC (STN-SR) and correlated Mobile Subscriber ISDN Number (C-MSISDN), and the MME_SRVCC 302 then triggers the SRVCC procedure with the MSC Server 301 enhanced for SRVCC via the Sv reference point. AMF 104 is aware of which PDU session is used for IMS voice service based on the DNN. In the step S404, the MSC Server 301 enhanced for SRVCC then initiates the session transfer procedure of the IMS service continuity procedure to the edge application server 114 and coordinates it with the CS handover procedure to the target UTRAN 203. Namely, the edge application server 114 may perform the session transfer procedure of the IMS service continuity procedure with the MSC server 301. For example, the edge application server 114 may obtain a serving PLMN single network slice selection assistance information (S-NSSAI) during a PDU Session Establishment procedure to perform the session transfer procedure.

In the step S405, upon receiving the indication of handover, the MSC server 301 may perform a resource allocation with the target UTRAN 203. In the step S406, MSC Server 301 enhanced for SRVCC then sends a PS-CS handover response to MME_SRVCC 302, wherein the PS-CS handover response includes the necessary CS HO command information for the UE 101 to access the UTRAN 203. In the step S407, MME_SRVCC 302 sends the forward relocation response message including the necessary CS HO command information to AMF 104. In the step S408, AMF 104 sends the handover command (HO CMD) to NG-RAN 202, and NG-RAN 202 sends the handover command to UE 101. After UE 101 moves to the coverage of UTRAN 203 and AMF 104 receives the forward relocation complete, AMF 104 requests PDU session release for all the PDU session.

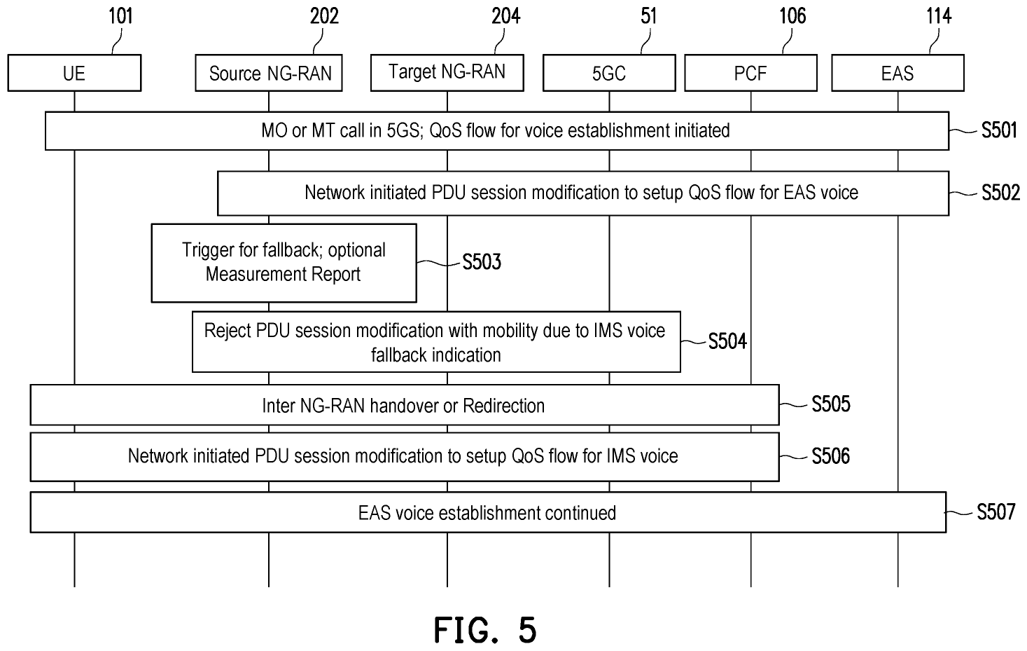

FIG. 5 is a flowchart of a method for supporting voice service continuity according to an embodiment of the disclosure. Referring to FIG. 5, the UE 101 may receive a mobile terminated (MT) call or initiate a mobile originated (MO) call. When the UE 101 is served by the 5G core network 51, the UE 101 has one or more ongoing PDU Sessions each including one or more QoS flows. The 5G core network 51 may include the network functions described in FIG. 1. Before the step S501, the serving AMF in the 5G core network 51 has sent an indication towards the UE 101 during the Registration procedure that the IMS voice over packet-switch (PS) session is supported.

In the step S501, the UE 101 camp on the source NG-RAN 202, and the edge application server 114 may initiate the 5G core network 51 to establish a QoS flow for IMS voice service. In the step S502, the 5G core network 51 may initiate PDU Session modification to setup QoS flow for IMS voice that may reach the source NG-RAN 202. Namely, the edge application server 114 may perform a PDU session modification procedure to set up the QoS configuration of the IMS voice service with the 5G core network 51. For example, the edge application server 114 may modify QoS profile of the QoS flow or plus associated QoS characteristics as per Service Provider Policy, such that the PDU session modification procedure may be implemented. The QoS profile may include a packet delay, an allocation and retention priority (ARP), a priority level, and a 5QI value. In the step S503, if source NG-RAN 202 is configured to support RAT fallback for IMS voice service, source NG-RAN 202 may decide to trigger a RAT fallback procedure according to UE's capabilities, network configuration and radio conditions. The source NG-RAN 201 may initiate measurement report solicitation from the UE 101.

In the step S504, the source NG-RAN 202 responds a rejection of the PDU session modification to setup QoS flow for IMS voice received in step S502 through sending a PDU Session Response message towards the 5G core network 51, wherein the PDU Session Response message includes an indication that mobility due to fallback for IMS voice is ongoing. The SMF in the 5G core network 51 may maintain the police and charging control (PCC) rule associated with the QoS flow. In the step S505, the source NG-RAN 202 may initiate Xn based Inter NG-RAN handover or N2 based inter NG-RAN handover, or redirection to E-UTRA connected to the 5G core network 51. In the step S506, after completion of the Inter NG-RAN (inter-RAT) handover or redirection to E-UTRA connected to the 5G core network 51, the SMF in the 5G core network 51 may re-initiate the PDU Session modification to setup QoS flow for IMS voice service. In the step S507, the edge application server 114 may continue to perform the IMS voice establishment procedure.

It should be noted that, in an embodiment of the disclosure, the optimization of the routing path may be done by the edge application server 114 according to the topology information and status information of each network node. The edge application server 114 may receive PDU session information of an IMS voice service, topology information and status information of each network node from a NEF or a NWADF. For example, the edge application server 114 may request the NEF to reply a specific QoS information for an IMS session of the IMS voice service. The edge application server 114 may request the NEF to report the bearer level event. The edge application server 114 may request the NWADF to reply slice load level information, observed service experience information, NF Load information, network performance information, UE mobility information, UE communication information, expected UE behavioral parameters, UE abnormal behavior information, user data congestion information, QoS Sustainability, etc. Therefore, the edge application server 114 may optimize the routing path of the control plane data or the user plane data of the IMS voice service according to the collected information from the NEF or the NWADF.

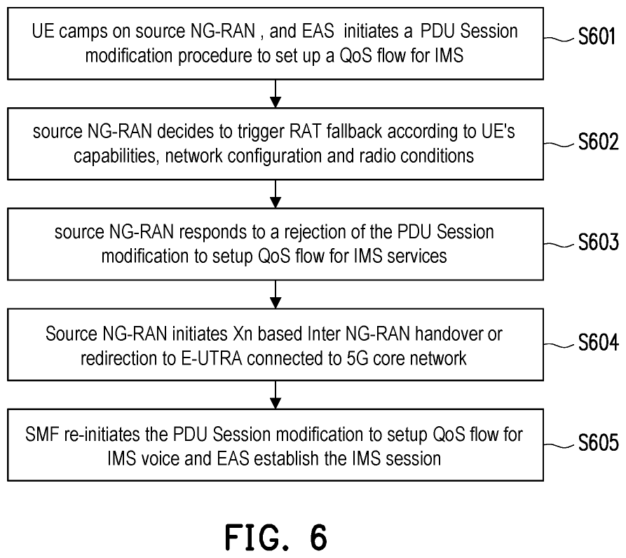

FIG. 6 is a flowchart of a method for supporting voice service continuity according to an embodiment of the disclosure. In the step S601, UE 101 may camp on source NG-RAN 202, and the edge application server 114 may initiate a PDU Session modification procedure to set up a QoS flow for IMS voice service. That is, in one embodiment of the disclosure, in response to a UE 101 camping on an NG-RAN base station (BS), the edge application server 114 may initiate the PDU session modification procedure to set up the QoS configuration of the IMS voice service. In the step S602, if the source NG-RAN 202 is configured to support RAT fallback for IMS voice service, the source NG-RAN 202 may decide to trigger a RAT fallback procedure according to UE's capabilities, network configuration and radio conditions. In the step S603, the source NG-RAN 202 may respond to a rejection of the PDU Session modification to setup QoS flow for IMS services. The edge application server 114 may receive a rejection of the PDU Session modification from the base station, i.e. the source NG-RAN 202. In the step S604, the source NG-RAN 202 may initiate Xn based Inter NG-RAN handover or redirection to E-UTRA connected to the 5G core network. In the step S605, the SMF in the 5G core network may re-initiate the PDU Session modification to setup QoS flow for IMS voice service and the edge application server 114 may establish the IMS session. That is, after completion of an inter-RAT handover or redirection, the edge application server 114 may perform an IMS voice establishment procedure.

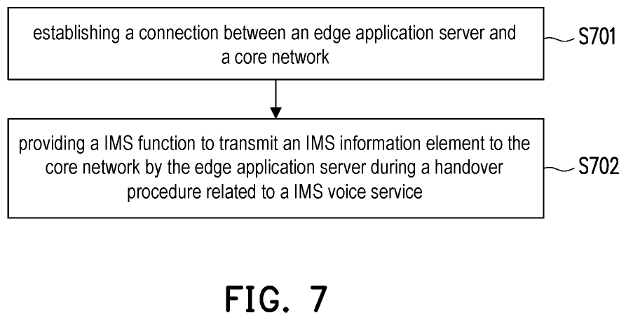

FIG. 7 is a flowchart illustrating a method for supporting voice service continuity according to an embodiment of the disclosure. Each of the steps in FIG. 7 is executed by an edge application server which may be implemented as a network apparatus disposed in a data network. In step S701, a connection between an edge application server and a core network is established. In step S702, an IMS function is provided to transmit an IMS information element to the core network by the edge application server during a handover procedure related to an IMS voice service.

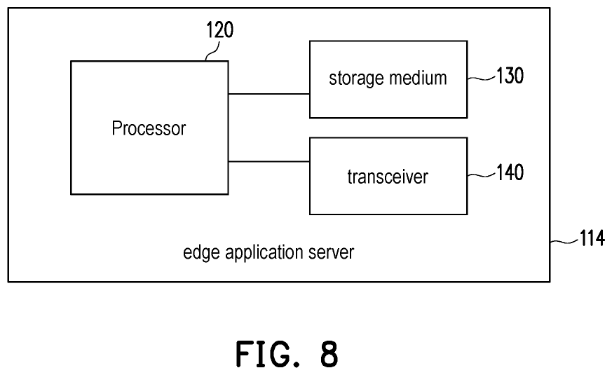

FIG. 8 is a block diagram illustrating an edge application server according to an embodiment of the disclosure. Referring to FIG. 8, the edge application server 114 may include at least (but not limited to) a processor 120, a storage medium 130 and a transceiver 140.

The processor 120 is, for example, a Central Processing Unit (CPU), or other programmable general purpose or special purpose microprocessor, a Digital Signal Processor (DSP), a programmable controller, an Application Specific Integrated Circuit (ASIC), a Graphics Processing Unit (GPU) or other similar components or a combination of the above components. The processor 120 is configured to perform a method for downlink reception in an unlicensed band which will be described afterward.

The storage medium 130 is coupled to the processor 120, and is, for example, any type of a fixed or movable Random Access Memory (RAM), a Read-Only Memory (ROM), a flash memory, a Hard Disk Drive (HDD), a Solid State Drive (SSD), or similar components or a combination of the above components. The storage medium 130 stores a plurality of modules or programs for the processor 120 to access, such that the processor 120 may execute various communication functions of the UE 100.

The transceiver 140 is coupled to the processor 120. The transceiver 140 may receive a DL signal and transmit a UL signal. The transceiver 140 may execute operations of Low Noise Amplifying (LNA), impedance matching, analog-to-digital (ADC) converting, digital-to-analog (DAC) converting, frequency mixing, up-down frequency conversion, filtering, amplifying and/or similar operations. The transceiver 140 may further include an antenna array, and the antenna array may include one or a plurality of antennas for transmitting and receiving omnidirectional antenna beams or directional antenna beams.

In view of the aforementioned descriptions, the voice service continuity can be supported through an edge application server including IMS functions. An SRVCC for an MC service may be implemented by using the edge application server close to the UE, and the handover latency may be reduced to meet the real-time requirement of the MC service. Further, the deployment of the edge application server including IMS functions for supporting voice service continuity may bring minimum impact to the current architecture, specifications, or the development of the next-generation network system. It should be noted that this disclosure does not require all the aforementioned advantages.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of” multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations could be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for supporting voice service continuity, the method comprising:
establishing a connection between an edge application server and a core network; and
providing an IMS function to transmit an IMS information element to the core network by the edge application server during a handover procedure related to an IMS voice service.

2. The method according to claim 1, wherein the edge application server in a data network is connected to a UE via a UPF.

3. The method according to claim 1, wherein the handover procedure comprises an SRVCC procedure, and the step of providing the IMS function to transmit the IMS information element to the core network during the handover procedure related to an IMS voice service comprises:
performing, by the edge application server, a session transfer procedure of an IMS service continuity procedure with an MSC server.

4. The method according to claim 1, wherein the handover procedure comprises a RAT fallback procedure, and the step of providing the IMS function to transmit the IMS information element to the core network during the handover procedure related to an IMS voice service comprises:
performing, by the edge application server, a PDU session modification procedure to set up QoS configuration of the IMS voice service.

5. The method according to claim 4, wherein the method further comprises:
after completion of an inter-RAT handover or redirection, performing a IMS voice establishment procedure by the edge application server.

6. The method according to claim 4, wherein the step of performing, by the edge application server, the PDU session modification procedure to set up QoS configuration of the IMS voice service comprises:
in response to a UE camping on a base station, initiating, by the edge application server, the PDU session modification procedure to set up the QoS configuration of the IMS voice service.

7. The method according to claim 5, wherein the method further comprises:
receiving, by the edge application server, a rejection of the PDU Session modification from the base station.

8. The method according to claim 1, wherein the IMS voice service is associated with a Mission-critical service.

9. The method according to claim 1, wherein the method further comprises:
receiving, by the edge application server, PDU session information of the IMS voice service from a NEF.

10. An edge application server, comprising:
a transceiver; and
a processor coupled to the transceiver and configured at least to:
establishing a connection between the edge application server and a core network; and
providing an IMS function to transmit an IMS information element to the core network during a handover procedure related to an IMS voice service.

11. The edge application server according to claim 10, wherein the edge application server in a data network is connected to a UE via a UPF.

12. The edge application server according to claim 10, wherein the handover procedure comprises an SRVCC procedure, and the processor is configured to:
performing a session transfer procedure of an IMS service continuity procedure with an MSC server.

13. The edge application server according to claim 10, wherein the handover procedure comprises a RAT fallback procedure, and the processor is configured to:
performing the PDU session modification procedure to set up the QoS configuration of the IMS voice service.

14. The edge application server according to claim 13, wherein the processor is configured to:
after completion of an inter-RAT handover or redirection, performing an IMS voice establishment procedure.

15. The edge application server according to claim 13, wherein the processor is configured to:
in response to a UE camping on a base station, initiating the PDU session modification procedure to set up the QoS configuration of the IMS voice service

16. The edge application server according to claim 15, wherein the processor is configured to:
receiving a rejection of the PDU Session modification from the base station.

17. The edge application server according to claim 10, wherein the IMS voice service is associated with a Mission-critical service.

18. The edge application server according to claim 10, wherein the edge application server receives PDU session information of the IMS voice service from a NEF.
